(19) United States
(12) Patent Application Publication
(10) Pub. No.: US 2025/0337328 A1
(43) Pub. Date: Oct. 30, 2025

(54) OPERATION METHOD OF A VOLTAGE CONVERTER

(71) Applicant: NOVATEK MICROELECTRONICS CORP., HSINCHU (TW)

(72) Inventors: YUEH LIN, TAIPEI CITY (TW); CHIH-PING CHENG, TAOYUAN CITY (TW); CHUN-YU HSIEH, MIAOLI COUNTY (TW)

(21) Appl. No.: 18/648,623

(22) Filed: Apr. 29, 2024

(51) Int. Cl. H02M 3/158

(52) U.S. Cl. CPC H02M 3/1582

(57) ABSTRACT

An operation method of a voltage converter is provided. The voltage converter includes a first switch, a second switch, a third switch, and a fourth switch. The first switch is coupled between the input of the voltage converter and a first node. The second switch is coupled between the first node and a reference voltage. The third switch is coupled between the reference voltage and a second node. The fourth switch is coupled between an output of the voltage converter and the second node. In the operation method, the voltage converter operates in a buck mode. In the buck mode, the first switch and the second switch are switched between an on state and an off state two times.

### BACKGROUND OF THE INVENTION

### Field of the Invention

The invention relates to an operation method, particularly to an operation method of a voltage converter.

### Description of the Related Art

Buck-boost converters may convert an input direct current (DC) voltage to a higher or lower output DC voltage. Buck-boost converters may operate with a buck or step-down functionality wherein buck legs, or sub-circuits, are in operation to convert an input voltage to a lower output voltage. Buck-boost converters may operate with a boost or step-up functionality, wherein boost legs, or sub-circuits, are in operation to convert an input voltage to a higher output voltage. Furthermore, buck-boost converters may operate with a buck-boost functionality, wherein buck legs and boost legs are both in operation at the same time, and the converter may convert DC voltage to a higher or a lower voltage. Buck-boost converters may be made with an inverting topology or a non-inverting topology. In an inverting topology, a buck-boost converter may produce output voltage that has an opposite polarity as the input voltage to the buck-boost converter. In a non-inverting topology, a buck-boost converter may produce output voltage that has a same polarity as the input voltage to the buck-boost converter.

### SUMMARY OF THE INVENTION

The invention provides an operation method of a voltage converter, which has advantages of less switching times, a low power loss, better operation efficiency, and the smaller ripple of an output voltage.

In an embodiment of the invention, an operation method of a voltage converter is provided. The voltage converter includes a first switch, a second switch, a third switch, and a fourth switch. The first switch is coupled between the input of the voltage converter and a first node. The second switch is coupled between the first node and a reference voltage. The third switch is coupled between the reference voltage and a second node. The fourth switch is coupled between the output of the voltage converter and the second node. The operation method includes: determining the voltage converter to operate in a buck mode that includes a first phase, a second phase, and a third phase; when controlling the voltage converter to operate in the first phase, turning on the first switch and the fourth switch and turning off the second switch and the third switch; when controlling the voltage converter to operate in the second phase successively after the first phase, turning on the second switch and the fourth switch and turning off the first switch and the third switch; and when controlling the voltage converter to operate in the third phase successively after the second phase, turning on the first switch and the fourth switch and turning off the second switch and the third switch.

To sum up, the operation method of the voltage converter switches the four switches at most two times in the buck mode to have advantages of less switching times, a low power loss, better operation efficiency, and the smaller ripple of the output voltage.

Below, the embodiments are described in detail in cooperation with the drawings to make easily understood the technical contents, characteristics and accomplishments of the invention.

### BRIEF DESCRIPTION OF THE DRAWINGS

FIG. 1 is a diagram schematically illustrating a voltage converter according to an embodiment of the invention;

FIG. 2 is a diagram schematically illustrating an operation method of a voltage converter that operates in a first phase, a third phase, a fourth phase, and a sixth phase according to an embodiment of the invention;

FIG. 3 is a diagram schematically illustrating a voltage converter that operates in a second phase according to an embodiment of the invention;

FIG. 4 is a diagram schematically illustrating a voltage converter that operates in a fifth phase according to an embodiment of the invention;

FIG. 5 is a diagram schematically illustrating the waveforms of the voltage of a first node, the voltage of a second node, and an inductor current in a buck mode according to an embodiment of the invention;

FIG. 6 is a diagram schematically illustrating the waveforms of the voltage of a first node, the voltage of a second node, and an inductor current in a boost mode according to an embodiment of the invention;

FIG. 7 is a flowchart of an operation method of a voltage converter according to an embodiment of the invention;

FIG. 8 is a diagram schematically illustrating the waveforms of the voltage of a first node, the voltage of a second node, and an inductor current in a boost mode and a buck mode according to an embodiment of the invention;

FIG. 9 is a diagram schematically illustrating a voltage converter according to another embodiment of the invention; and

FIG. 10 is a diagram schematically illustrating a frequency versus output power curves of a voltage converter according to an embodiment of the invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

Unless otherwise specified, some conditional sentences or words, such as “can”, “could”, “might”, or “may”, usually attempt to express what the embodiment in the invention has, but it can also be interpreted as a feature, element, or step that may not be needed. In other embodiments, these features, elements, or steps may not be required.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Certain terms are used throughout the description and the claims to refer to particular components. One skilled in the art appreciates that a component may be referred to using different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to encompass any indirect or direct connection. Accordingly, if this disclosure mentions that a first device is coupled with a second device, it means that the first device may be directly or indirectly connected to the second device through electrical connections, wireless communications, optical communications, or other signal connections with/without other intermediate devices or connection means.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the articles “a” and “the” includes the meaning of “one or at least one” of the elements or components. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. The examples in the present specification do not limit the claimed scope of the invention.

In the following description, an operation method of a voltage converter will be described. The operation method of the voltage converter switches four switches at most two times in a buck mode to have advantages of less switching times, a low power loss, better operation efficiency, and the smaller ripple of an output voltage. The voltage converters described below may also be applied to other circuit configurations.

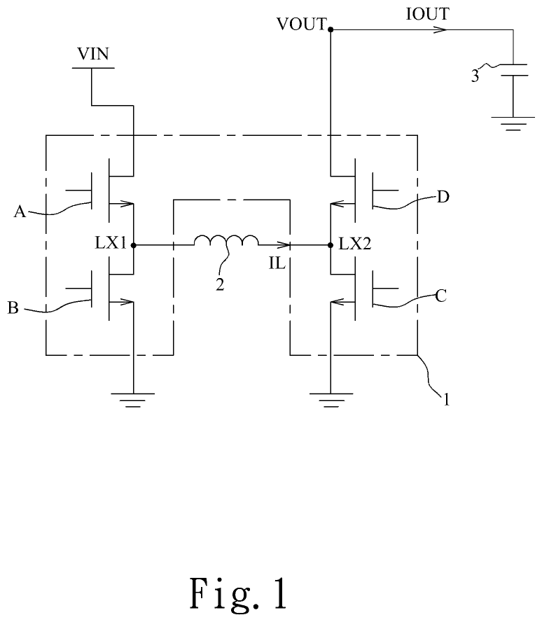

FIG. 1 is a diagram schematically illustrating a voltage converter according to an embodiment of the invention. Referring to FIG. 1, an operation method of a voltage converter 1 is introduced as follows. The voltage converter 1 includes a first switch A, a second switch B, a third switch C, and a fourth switch D. In some embodiments, the first switch A, the second switch B, the third switch C, and the fourth switch D may be, but not limited to, metal-oxide-semiconductor field effect transistors (MOSFETs). The first switch A, the second switch B, the third switch C, and the fourth switch D can be integrated in an integrated circuit (IC). The first switch A is coupled between the input of the voltage converter 1 and a first node LX1. The second switch B is coupled between the first node LX1 and a reference voltage. The reference voltage may be, but not limited to, a grounding voltage. The third switch C is coupled between the reference voltage and a second node LX2. The fourth switch D is coupled between the output of the voltage converter 1 and the second node LX2. The output of the voltage converter 1 is coupled to a loading capacitor 3. In some embodiments, the first node LX1 is coupled to the second node LX2 through an inductor 2. The input of the voltage converter 1 may receive an input voltage VIN and the output of the voltage converter 1 may generate an output voltage VOUT and an output current IOUT. The output voltage VOUT and the output current IOUT form an output power POUT.

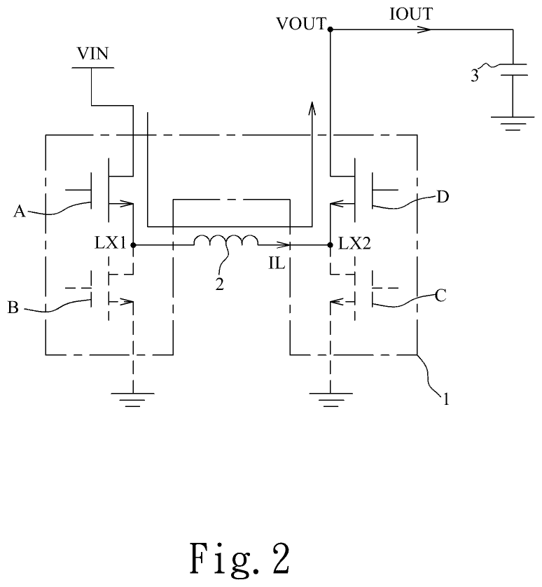

FIG. 2 is a diagram schematically illustrating an operation method of a voltage converter that operates in a first phase, a third phase, a fourth phase, and a sixth phase according to an embodiment of the invention. Referring to FIG. 2, the first switch A and the fourth switch D are turned on and the second switch B and the third switch C are turned off. For convenience and clarity, the first switch A and the fourth switch D are represented with solid lines and the second switch B and the third switch C are represented with dashed lines. In such a case, an inductor current IL sequentially flows through the first switch A, the inductor 2, and the fourth switch D.

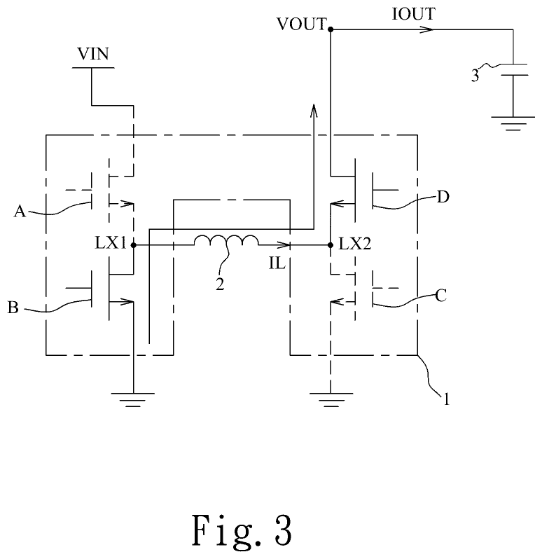

FIG. 3 is a diagram schematically illustrating a voltage converter that operates in a second phase according to an embodiment of the invention. Referring to FIG. 3, the second switch B and the fourth switch D are turned on and the first switch A and the third switch C are turned off. For convenience and clarity, the second switch B and the fourth switch D are represented with solid lines and the first switch A and the third switch C are represented with dashed lines. In such a case, the inductor current IL sequentially flows through the second switch B, the inductor 2, and the fourth switch D.

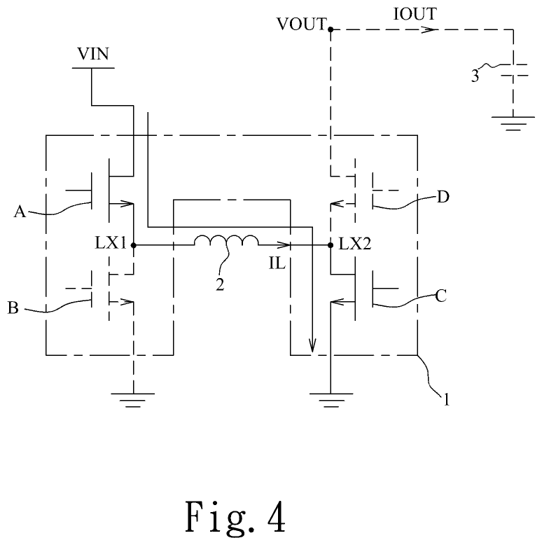

FIG. 4 is a diagram schematically illustrating a voltage converter that operates in a fifth phase according to an embodiment of the invention. Referring to FIG. 4, the first switch A and the third switch C are turned on and the second switch B and the fourth switch D are turned off. For convenience and clarity, the first switch A and the third switch C are represented with solid lines and the second switch B and the fourth switch D are represented with dashed lines. In such a case, the inductor current IL sequentially flows through the first switch A, the inductor 2, and the third switch C.

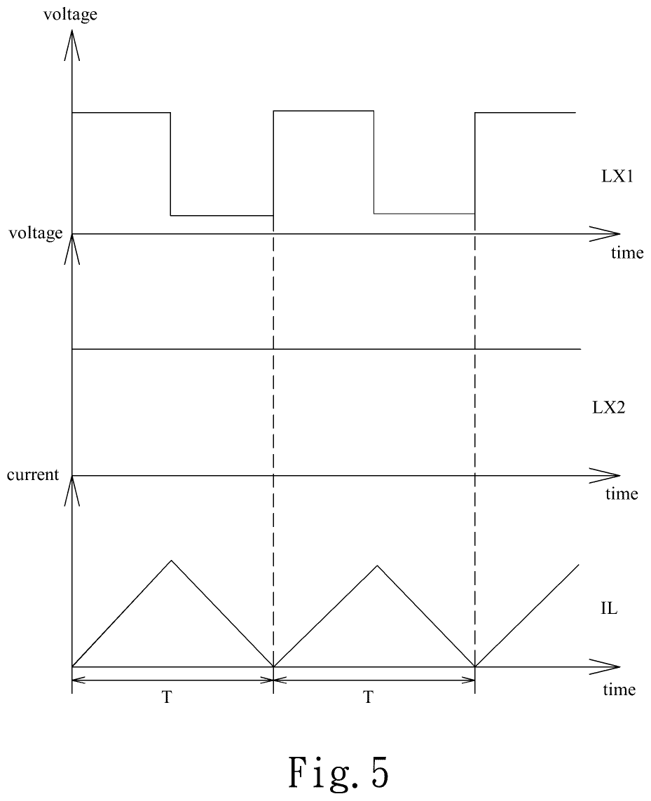

FIG. 5 is a diagram schematically illustrating the waveforms of the voltage of a first node, the voltage of a second node, and an inductor current in a buck mode according to an embodiment of the invention. Referring to FIG. 2, FIG. 3, and FIG. 5, the voltage converter 1 operates in the buck mode when the input voltage VIN is greater than the output voltage VOUT. During each cycle T of the buck mode, the voltage of the first node LX1 transitions from a high-level voltage to a low-level voltage, the voltage of the second node LX2 keeps constant, and the inductor current IL sequentially increases and decreases. Each cycle T of the buck phase includes a first time period and a second time period that sequentially occur. In the first time period, the first switch A and the fourth switch D are turned on and the second switch B and the third switch C are turned off, as illustrated in FIG. 2. In the second time period, the second switch B and the fourth switch D are turned on and the first switch A and the third switch C are turned off, as illustrated in FIG. 3.

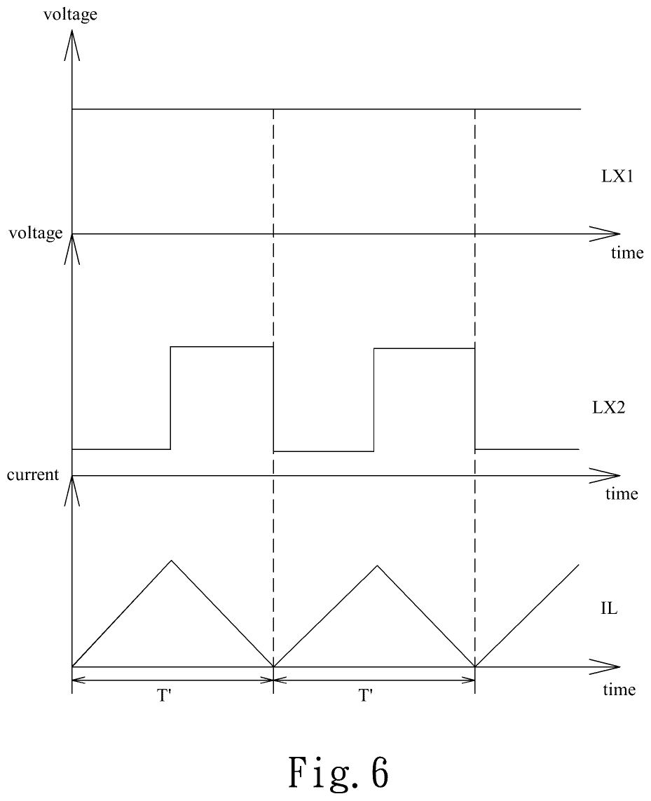

FIG. 6 is a diagram schematically illustrating the waveforms of the voltage of a first node, the voltage of a second node, and an inductor current in a boost mode according to an embodiment of the invention. Referring to FIG. 2, FIG. 4, and FIG. 6, the voltage converter 1 operates in the boost mode when the input voltage VIN is less than the output voltage VOUT. During each cycle T′ of the boost mode, the voltage of the first node LX1 keeps constant, the voltage of the second node LX2 transitions from a low-level voltage to a high-level voltage, and the inductor current IL sequentially increases and decreases. Each cycle T′ of the boost mode includes a third time period and a fourth time period that sequentially occur. In the third time period, the first switch A and the third switch C are turned on and the second switch B and the fourth switch D are turned off, as illustrated in FIG. 4. In the fourth time period, the first switch A and the fourth switch D are turned on and the second switch B and the third switch C are turned off, as illustrated in FIG. 2.

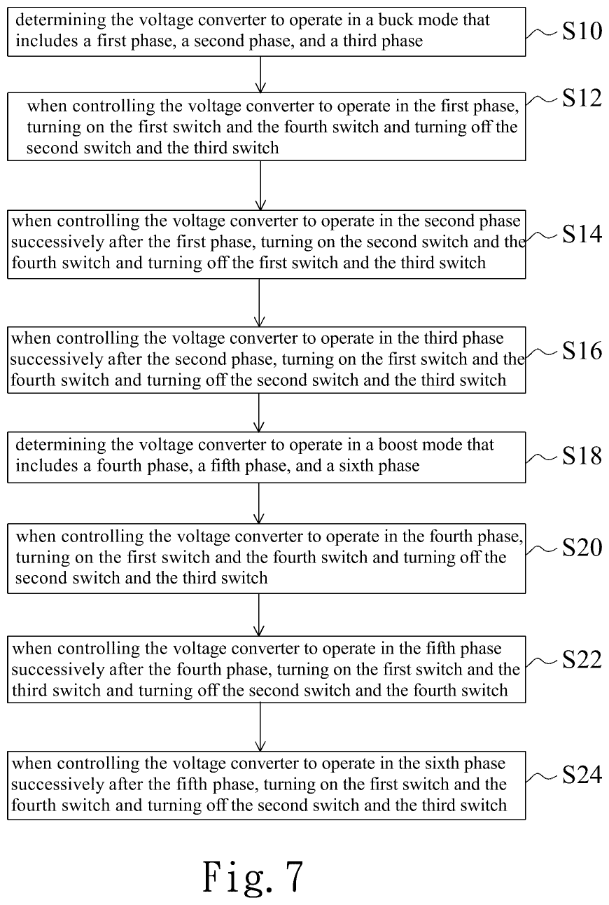

FIG. 7 is a flowchart of an operation method of a voltage converter according to an embodiment of the invention. Referring to FIG. 7 and FIG. 1, the operation method of the voltage converter 1 is introduced as follows. In Step S10, the operation method determines the voltage converter 1 to operate in a buck mode that includes a first phase, a second phase, and a third phase. In Step S12, when controlling the voltage converter 1 to operate in the first phase, the first switch A and the fourth switch D are turned on and the second switch B and the third switch C are turned off. In Step S14, when controlling the voltage converter 1 to operate in the second phase successively after the first phase, the second switch B and the fourth switch D are turned on and the first switch A and the third switch C are turned off. In Step S16, when controlling the voltage converter 1 to operate in the third phase successively after the second phase, the first switch A and the fourth switch D are turned on and the second switch B and the third switch C are turned off. In other words, the first switch A and the second switch B are switched between an on state and an off state at most two times in the buck mode. In some embodiments, the operation method may further include Steps S18-S24. In Step S18, the operation method determines the voltage converter 1 to operate in a boost mode that includes a fourth phase, a fifth phase, and a sixth phase. In Step S20, when controlling the voltage converter 1 to operate in the fourth phase, the first switch A and the fourth switch D are turned on and the second switch B and the third switch C are turned off. In Step S22, when controlling the voltage converter 1 to operate in the fifth phase successively after the fourth phase, the first switch A and the third switch C are turned on and the second switch B and the fourth switch D turned off. In Step S24, when controlling the voltage converter 1 to operate in the sixth phase successively after the fifth phase, the first switch A and the fourth switch D are turned on and the second switch B and the third switch C are turned off. That is to say, the third switch C and the fourth switch D are switched between an on state and an off state at most two times in the boost mode. Since the voltage converter 1 operates in the buck mode or the boost mode for one cycle, the voltage converter 1 switches the first switch A, the second switch B, the third switch C, and the fourth switch D only two times during one cycle, thereby reducing a power loss and the ripple of the output voltage VOUT. As a result, the operation method has advantages of less switching times, a low power loss, better operation efficiency, and the smaller ripple of the output voltage VOUT. Provided that substantially the same result is achieved, the steps of the flowchart shown in FIG. 7 need not be in the exact order shown and need not be contiguous, that is, other steps can be intermediate.

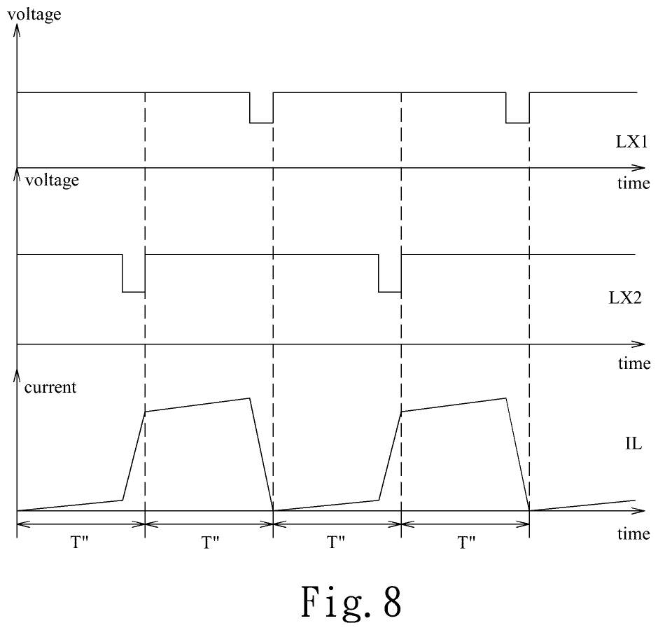

FIG. 8 is a diagram schematically illustrating the waveforms of the voltage of a first node, the voltage of a second node, and an inductor current in a boost mode and a buck mode according to an embodiment of the invention. Referring to FIGS. 2-4, and FIG. 8, the voltage converter 1 alternately operates in the boost mode and the buck mode when the input voltage VIN is equal to the output voltage VOUT. During each cycle T″ of the boost mode, the voltage of the first node LX1 keeps constant, the voltage of the second node LX2 transitions between a low-level voltage and a high-level voltage, and the inductor current IL increases slowly and then rapidly. Each cycle T″ of the boost mode includes a first time interval and a second time interval that sequentially occur. In the first time interval, the first switch A and the fourth switch D are turned on and the second switch B and the third switch C are turned off, as illustrated in FIG. 2. In the second time interval, the first switch A and the third switch C are turned on and the second switch B and the fourth switch D are turned off, as illustrated in FIG. 4. During each cycle T″ of the buck mode, the voltage of the first node LX1 transitions between a low-level voltage and a high-level voltage, the voltage of the second node LX2 keeps constant, and the inductor current IL increases slowly and then decreases rapidly. Each cycle T″ of the buck mode includes a third time interval and a fourth time interval that sequentially occur. In the third time interval, the first switch A and the fourth switch D are turned on and the second switch B and the third switch C are turned off, as illustrated in FIG. 2. In the fourth time interval, the second switch B and the fourth switch D are turned on and the first switch A and the third switch C are turned off, as illustrated in FIG. 3.

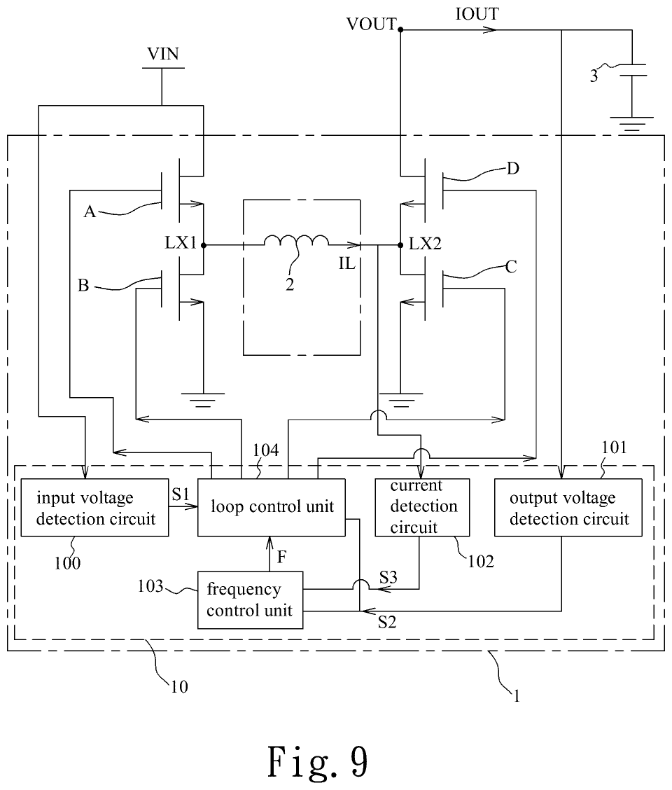

FIG. 9 is a diagram schematically illustrating a voltage converter according to another embodiment of the invention. Referring to FIG. 9, the voltage converter 1 may further include a switch controller 10 coupled to the control terminals of the first switch A, the second switch B, the third switch C, and the fourth switch D, the second node LX2, and the inductor 2. The switch controller 10 detects the input voltage VIN, the output voltage VOUT, and the inductor current IL flowing through the inductor 2. The switch controller 10 turns on the first switch A and the fourth switch D and turns off the second switch B and the third switch C based on the input voltage VIN, the output voltage VOUT, and the inductor current IL in the first phase, the third phase, the fourth phase, or the sixth phase. The switch controller 10 turns on the second switch B and the fourth switch D and turns off the first switch A and the third switch C based on the input voltage VIN, the output voltage VOUT, and the inductor current IL in the second phase. The switch controller 10 turns on the first switch A and the third switch C and turns off the second switch B and the fourth switch D based on the input voltage VIN, the output voltage VOUT, and the inductor current IL in the fifth phase. Specifically, the switch controller 10 may control the voltage converter 1 to operate in the buck mode or the boost mode for one cycle.

In some embodiments, the switch controller 10 may include an input voltage detection circuit 100, an output voltage detection circuit 101, a current detection circuit 102, a frequency control unit 103, and a loop control unit 104. The input voltage detection circuit 100 is coupled to the input of the voltage converter 1 and the first switch A. The output voltage detection circuit 101 is coupled to the output of the voltage converter 1 and the fourth switch D. The current detection circuit 102 is coupled to the second node LX2 and the inductor 2. The frequency control unit 103 is coupled to the output voltage detection circuit 101 and the current detection circuit 102. The loop control unit 104 is coupled to the input voltage detection circuit 100, the output voltage detection circuit 101, the current detection circuit 102, the frequency control unit 103, and the control terminals of the first switch A, the second switch B, the third switch C, and the fourth switch D.

The input voltage detection circuit 100 generates a first analog signal S1 based on the input voltage VIN. The output voltage detection circuit 101 generates a second analog signal S2 based on the output voltage VOUT. The current detection circuit 102 detects the inductor current IL and generates a third analog signal S3 based on the inductor current IL. The frequency control unit 103 receives the second analog signal S2 and the third analog signal S3 to determine a current relationship between the inductor current IL and the output current IOUT, thereby generating a frequency F. The loop control unit 104 receives the first analog signal S1, the frequency F, and the second analog signal S2 and turns on or off the first switch A, the second switch B, the third switch C, and the fourth switch D based on the first analog signal S1, the frequency F, and the second analog signal S2. The loop control unit 104 switches the first switch A, the second switch B, the third switch C, and the fourth switch D at the frequency F.

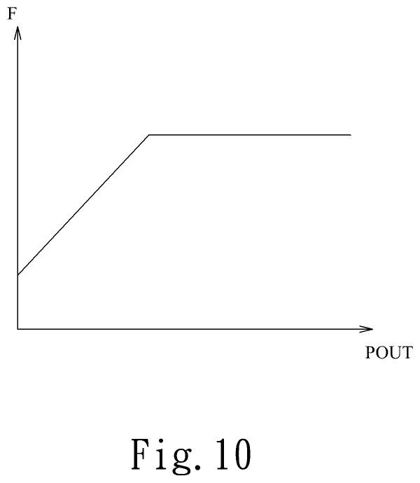

FIG. 10 is a diagram schematically illustrating a frequency versus output power curves of a voltage converter according to an embodiment of the invention. Referring to FIG. 10 and FIG. 9, the frequency F keeps constant when the output power POUT is greater than or equal to a given power. In FIG. 10, the output power POUT can be replaced by the output current IOUT. When the output power POUT is replaced by the output current IOUT, the given power is replaced by a given current. When the output power POUT is less than the given power, the switch controller 10 switches the first switch A, the second switch B, the third switch C, and the fourth switch D in a pulse-frequency modulation (PFM) mode. In the PFM mode, the output power POUT generated by the output of the voltage converter 1 is directly proportional to the frequency F at which the switch controller 10 switches the first switch A, the second switch B, the third switch C, and the fourth switch D. For example, the output power POUT is directly and linearly proportional to the frequency F. The lower the output power POUT, the lower the frequency F.

According to the embodiments provided above, the operation method of the voltage converter switches the four switches at most two times in the boost mode or the buck mode to have advantages of less switching times, a low power loss, better operation efficiency, and the smaller ripple of the output voltage.

The embodiments described above are only to exemplify the invention and not to limit the scope of the invention. Therefore, any equivalent modification or variation according to the shapes, structures, features, or spirit disclosed by the invention is to be also included within the scope of the invention.

What is claimed is:

1. An operation method of a voltage converter, the voltage converter comprising a first switch, a second switch, a third switch, and a fourth switch, the first switch coupled between an input of the voltage converter and a first node, the second switch coupled between the first node and a reference voltage, the third switch coupled between the reference voltage and a second node, the fourth switch coupled between an output of the voltage converter and the second node, and the operation method comprising:
determining the voltage converter to operate in a buck mode that includes a first phase, a second phase, and a third phase;
when controlling the voltage converter to operate in the first phase, turning on the first switch and the fourth switch and turning off the second switch and the third switch;
when controlling the voltage converter to operate in the second phase successively after the first phase, turning on the second switch and the fourth switch and turning off the first switch and the third switch; and
when controlling the voltage converter to operate in the third phase successively after the second phase, turning on the first switch and the fourth switch and turning off the second switch and the third switch.

2. The operation method of the voltage converter according to claim 1, further comprising:
determining the voltage converter to operate in a boost mode that includes a fourth phase, a fifth phase, and a sixth phase;
when controlling the voltage converter to operate in the fourth phase, turning on the first switch and the fourth switch and turning off the second switch and the third switch;
when controlling the voltage converter to operate in the fifth phase successively after the fourth phase, turning on the first switch and the third switch and turning off the second switch and the fourth switch; and
when controlling the voltage converter to operate in the sixth phase successively after the fifth phase, turning on the first switch and the fourth switch and turning off the second switch and the third switch.

3. The operation method of the voltage converter according to claim 2, wherein the third switch and the fourth switch are switched between an on state and an off state two times in the boost mode.

4. The operation method of the voltage converter according to claim 1, wherein the first node is coupled to the second node through an inductor.

5. The operation method of the voltage converter according to claim 4, wherein the input of the voltage converter receives an input voltage and the output of the voltage converter generates an output voltage.

6. The operation method of the voltage converter according to claim 5, wherein when the input voltage is greater than the output voltage, the voltage converter operates in the buck mode.

7. The operation method of the voltage converter according to claim 5, wherein when the input voltage is less than the output voltage, the voltage converter operates in the boost mode.

8. The operation method of the voltage converter according to claim 5, wherein when the input voltage is equal to the output voltage, the voltage converter alternately operates in the boost mode and the buck mode.

9. The operation method of the voltage converter according to claim 1, wherein the first switch and the second switch are switched between an on state and an off state two times in the buck mode.

10. The operation method of the voltage converter according to claim 1, wherein the first switch, the second switch, the third switch, and the fourth switch are switched in a pulse-frequency modulation (PFM) mode.
